(19) United States
(12) Patent Application Publication
(10) Pub. No.: US 2025/0385456 A1
(43) Pub. Date: Dec. 18, 2025

(54) FEMALE TERMINAL FOR A PRINTED CIRCUIT BOARD AND PRINTED CIRCUIT BOARD ARRANGEMENT

(71) Applicant: Lear Corporation, Southfield, MI (US)

(72) Inventors: Michaela Weger, Remscheid (DE); Sven Vesper, Remscheid (DE)

(73) Assignee: Lear Corporation, Southfield, MI (US)

(21) Appl. No.: 19/230,545

(22) Filed: Jun. 6, 2025

(30) Foreign Application Priority Data
Jun. 17, 2024 (DE) 10 2024 117 016.6

(51) Int. Cl. H01R 13/187; H01R 12/70; H01R 12/71; H01R 13/50

(52) U.S. Cl. CPC H01R 13/187; H01R 12/7052; H01R 12/7082; H01R 12/716; H01R 13/50

(57) ABSTRACT

A female terminal for a printed circuit board has a plug receptacle, a first spring tongue and a positioning arm. The plug receptacle and the first spring tongue are at least partially surrounded by a surrounding wall. A printed circuit board arrangement includes a printed circuit board and a female terminal. The female terminal is arranged at least partially within the printed circuit board and is electrically conductively connected to a conductor track of the printed circuit board.

### CROSS-REFERENCE TO RELATED APPLICATIONS

This application claims the benefit of and priority to German Patent Application 10 2024 117 016.6, filed Jun. 17, 2024, the disclosure of which is hereby incorporated by reference in its entirety as though fully set forth herein.

### TECHNICAL FIELD

The instant disclosure relates to a female terminal for a printed circuit board and a printed circuit board arrangement with a female terminal, a printed circuit board and a plug.

### SUMMARY

The female terminal has at least one plug receptacle, at least one first spring tongue and at least one positioning arm. The plug receptacle is configured and designed to at least partially receive a plug. The first spring tongue is arranged at least partially adjacent to the plug receptacle and the first spring tongue is configured and designed to hold the plug at least partially in the plug receptacle. The positioning arm is configured and designed to position the female terminal on the printed circuit board.

Female terminals are known in a variety of embodiments from the prior art. For example, it is known from EP2 236 330 A1 or from EP 2 897 230 B1 to provide a spring tongue on the printed circuit board in order to hold the plug in a position relative to the printed circuit board. However, both EP 2 236 330 A1 and EP 2 897 230 B1 suggest that the female terminal is essentially formed in a plate-shape. For positioning on the printed circuit board, the female terminal is provided with two curved webs that are to be inserted into corresponding openings in the printed circuit board. Experience has shown that the webs tend to break even under low loads. In addition, with this type of design, the female terminal requires a relatively large amount of space when mounted, so that the printed circuit board is not available for other connections at this point.

It is also known from the prior art that the female terminal has an outer contour that essentially corresponds to an inner contour of a corresponding opening in the printed circuit board. The spring tongues are attached outside this outer contour. However, such a design of the female terminal also causes the female terminal, in particular the spring tongues, to become casily damaged.

The instant disclosure is therefore based, at least in part, on the task of providing a female terminal and a printed circuit board arrangement which have improved resistance to damage and a reduced space requirement.

According to at least some embodiments of the instant disclosure, the task is solved by one or more features, such as via the plug receptacle and the first spring tongue being at least partially surrounded by a surrounding wall. As a result, the first spring tongue in particular is protected from damage. Furthermore, the female terminal has a more compact shape and requires less installation space. In addition, the female terminal is arrangeable essentially within a printed circuit board. The female terminal according to at least some embodiments of the instant disclosure increases the safety of the plug receptacle and the first spring tongue while reducing the space required. For a more compact form of the female terminal, it is also particularly advantageous that the plug receptacle and/or the first spring tongue is essentially completely surrounded by the surrounding wall.

If a plug is inserted into the plug receptacle in order to establish an electrically conductive connection with the female terminal, the first spring tongue is optionally elastically deformed by the plug, so that the first spring tongue bears against the plug under a preload and establishes an advantageous electrical contact.

In some examples, the female terminal is configured and designed to be used in an electric vehicle, for example in an electric passenger car.

Alternatively or additionally, it is advantageously provided that the female terminal is designed and configured for use in the high-voltage sector. In particular, the female terminal is provided in such a form that the female terminal is configured and designed to be used in the high-volt range or that the female terminal is configured and designed for use with high-voltage current.

To reduce the amount of material required, it is also possible for the surrounding wall to have at least one indentation and/or at least one recess. Advantageously, it is provided that the at least one indentation or at least one recess is formed between two adjacent positioning arms.

In an advantageous embodiment of the instant disclosure, it is provided that the surrounding wall encloses at least one interior space. Furthermore, the female terminal is advantageously configured such that the first spring tongue is arranged at least partially within the interior space. In particular, the first spring tongue delimits the plug receptacle within the interior space. In some examples, the first spring tongue is arranged at least partially within the interior space. In some examples, the first spring tongue is arranged completely in the interior space.

The required installation space of the female terminal is further reduced by, for example, providing that the first spring tongue has a spring root portion, and that the spring root portion protrudes from the interior space. In particular, it is advantageous if it is provided that only the spring root portion protrudes from the interior space. In these embodiments of the female terminal, it is advantageously provided that the plug receptacle is arranged completely within the interior space.

Furthermore, it is, for example, provided that the first spring tongue has at least one spring portion, and that the circumferential wall extends beyond the spring portion. Optionally, it is provided that the first spring tongue, in particular the spring portion, has an extension that is smaller than a parallel extension of the circumferential wall. It is further advantageous if the spring portion extends in a height direction. The spring portion is protected by the surrounding wall and the risk of damage is further reduced.

The material requirement is reduced if it is provided that a main wall portion of the surrounding wall extends beyond the spring portion. In particular, it is provided that the spring portion is arranged within the interior space. Furthermore, it may be provided that the first spring tongue is arranged on the main wall portion, optionally integrally formed with the main wall portion. In particular, it is provided that the main wall portion has a length, for example a length which extends substantially orthogonally to the height direction, which is greater or less than a length of a further portion of the surrounding wall, for example a side portion of the surrounding wall. Optionally, it is provided that the main wall portion is a portion of the surrounding wall that has the greatest length.

To increase the load-bearing capacity of the female terminal, it is advantageously provided that the spring portion has at least one end portion orientated towards the surrounding wall. In particular, the female terminal is configured in such a way that the end section is at least partially supported against the surrounding wall when a plug is inserted into the plug receptacle. Optionally, the end portion at least partially rests on the main wall portion of the surrounding wall when a plug is inserted into the plug receptacle. Optionally, the end portion is at least partially supported on the surrounding wall, for example the main wall portion, when a plug is inserted into the plug receptacle in order to increase the contact force. In particular, it is provided that at least the spring portion is elastically deformable. The elastic deformability of the spring portion, or of the entire first spring tongue, causes the end portion to deform elastically towards the surrounding wall when a plug is inserted, until the end portion touches the surrounding wall and is supported against the surrounding wall.

According to a further advantageous embodiment of the female terminal, it is provided that the first spring tongue is formed starting from a main wall portion. In particular, it is provided that the first spring tongue and the positioning arm are arranged on the same main wall portion. For improved force distribution and improved resistance of the female terminal, it is provided that the first spring tongue and the positioning arm are arranged at opposite end portions of the main wall portion. The two opposite end portions of the main wall portion define an extension of the surrounding wall, for example a height extension of the main wall portion. Furthermore, it is advantageous if the first spring tongue extends in the interior space towards the positioning arm. Advantageously, it is provided that the first spring tongue extends from the spring root portion in the direction of the end portion of the first spring tongue towards the positioning arm. In particular, the end portion of the first spring tongue is arranged closer to the positioning arm than the spring root portion of the first spring tongue.

Alternatively or additionally, it is possible that at least one second spring tongue is present. In particular, it is provided that the first spring tongue is at least partially orientated in the opposite direction to the second spring tongue. Optionally, the second spring tongue is at least partially of the same design as the first spring tongue, in particular the second spring tongue thus has at least partially the same features as the first spring tongue. Optionally, the second spring tongue is arranged parallel to the first spring tongue, next to the first spring tongue. In particular, it is provided that the female terminal has the second spring tongue.

An opposing orientation of the two spring tongues facilitates inserting a plug from different directions. Furthermore, the plug is held in the plug receptacle in an improved manner due to the opposing orientation of the spring tongues. In particular, it is advantageous if the first spring tongue and the second spring tongue are formed starting from opposite main wall portions of the surrounding wall. Optionally, a spring root portion of the first spring tongue is arranged opposite to an end portion of the second spring tongue and a spring root portion of the second spring tongue is arranged opposite to an end portion of the first spring tongue. For example, it is provided that the end portion of the first spring tongue and the spring root portion of the second spring tongue face each other and/or the end portion of the second spring tongue and the spring root portion of the first spring tongue face each other.

In a further embodiment of the female terminal, it is proposed that at least the first spring tongue is at least partially or completely curved. Furthermore, optionally, the first spring tongue has at least one contact point for a plug. For example, it is provided that the contact point is arranged in a spring portion of the first spring tongue or that the spring portion of the first spring tongue is formed as a contact point. If it is provided that the contact point is formed at a peak of the curvature, the electrical contacting of the plug is improved. In particular, it is provided that the curvature is formed on the spring portion of the first spring tongue.

In order to further reduce the installation space of the female terminal, it is provided that the plug receptacle is orientated in such a way that, in a mounted state, the plug receptacle extends essentially parallel to the printed circuit board, in particular parallel to a surface of the printed circuit board. According to at least some embodiments of the present disclosure, the mounted state is to be understood as the state in which the female terminal is mounted on a printed circuit board in such a way that the female terminal and the printed circuit board can be used as intended.

In particular, it is advantageous if the plug receptacle extends essentially parallel to a positioning arm wing of the positioning arm. Optionally, the plug receptacle is configured and designed so that, in the mounted state, a plug inserted into the plug receptacle extends essentially parallel to the printed circuit board, in particular parallel to a surface of the printed circuit board. The extension of the plug receptacle describes the way in which the plug receptacle is shaped from an insertion section to an outlet section. The insertion portion is optionally a portion of the plug receptacle that is configured and designed to be the first to be penetrated by the plug when the plug is inserted. In particular, it is provided that the outlet section is arranged at an end of the plug receptacle opposite the insertion section. It is advantageous if the outlet portion is a portion of the plug receptacle which is configured and designed to be the last to be passed through by the plug when the plug is inserted.

It should also be noted that the plug receptacle can also be referred to as a plug recess. In particular, it is provided that the plug receptacle is formed as a passageway. In particular, the plug receptacle is configured and designed so that the plug passes through the plug receptacle. Alternatively, it is provided that the plug receptacle has a closed end section, for example, whereby the plug can be placed against the closed end section.

To facilitate the positioning of the female terminal on the printed circuit board, it is proposed that the positioning arm extends substantially in an extension of the surrounding wall. In particular, it is provided that the positioning arm extends substantially along a main wall portion of the surrounding wall. Optionally, the positioning arm protrudes from a main wall portion. It is advantageous for the resistance of the female terminal if it is provided that in the mounted state the positioning arm abuts at least partially, such as completely, the printed circuit board, optionally at least in a portion substantially flush with the printed circuit board. For example, the positioning arm is configured to be soldered to the printed circuit board or a contact point on the printed circuit board.

The female terminal is further protected if it is provided that the surrounding wall has at least one protective protrusion. If it is also provided that the protective protrusion is arranged on a side wall portion that is different from a main wall portion, the protection of the female terminal against deformation is further improved. In addition, the protective protrusion improves inserting the female terminal into the printed circuit board or into a recess in the printed circuit board. In particular, it is advantageous if it is provided that the protective protrusion is arranged on a side wall portion adjacent to the main wall portion. Optionally, the spring root portion protrudes from the main wall portion by a spring root extension and that the spring root extension is approximately as large as or larger than a protective protrusion extension by which the protective protrusion protrudes from the side wall portion. In particular, the spring root portion is protected by the protective protrusion.

In a further embodiment of the female terminal, it is provided that the positioning arm has at least one positioning arm web and at least one positioning arm wing, and that the positioning arm wing projects at an angle from the positioning arm, in particular from the positioning arm web. In particular, it is provided that the angle is between 45° and 135°. Optionally, the angle is between 60° and 120°. Advantageously, it is provided that the angle is approximately 75° or approximately 90°. For improved attachment of the female terminal to the printed circuit board, it is optionally provided that the printed circuit board has at least one receptacle, and that the receptacle is configured and designed to at least partially receive the positioning arm wing. Additionally or alternatively, it is particularly provided that the positioning arm wing is configured and designed to at least partially abut against the printed circuit board, in particular against a conductor track of the printed circuit board. Optionally, the positioning arm wing is configured and designed to enter into an electrically conductive connection with the printed circuit board, in particular with a conductor track of the printed circuit board.

Producing of the female terminal is improved in particular if the female terminal is formed in one piece. Optionally, the female terminal is formed in one piece from a blank made of sheet metal by bending. This prevents interactions between different materials. Alternatively or additionally, it may also be provided that the female terminal is at least partially or completely made using an additive manufacturing process, e.g. 3D printing.

In order to produce a surrounding wall, it is particularly provided that the surrounding wall has at least one joint. Optionally, it is provided that two ends of a blank are joined together at the joint. In order to prevent the female terminal from opening unintentionally, it is advantageous if the two ends are joined at the joint by means of a dovetail joint. A tongue and groove joint is optionally provided as an alternative to the dovetail joint or additionally. Improved load distribution is achieved if the joint is arranged on a side wall portion of the surrounding wall.

According to a second aspect, the present disclosure comprises a printed circuit board arrangement. The printed circuit board arrangement has at least one printed circuit board and at least one female terminal according to one of the preceding embodiments. The female terminal is arranged at least partially within the printed circuit board, in particular within a recess in the printed circuit board, wherein the female terminal is electrically conductively connected to at least one conductor track of the printed circuit board. Since the printed circuit board arrangement according to at least some embodiments of the instant disclosure has a female terminal according to embodiments of the instant disclosure, the embodiments and advantages described with respect to the female terminal apply equally to the printed circuit board arrangement and vice versa.

Advantageously, the printed circuit board has at least one receptacle. Optionally, the receptacle is configured and designed to receive a positioning arm wing of the positioning arm. In particular, the printed circuit board arrangement is designed such that a positioning arm wing of the positioning arm is at least partially arranged in the receptacle of the printed circuit board.

### BRIEF DESCRIPTION OF THE DRAWINGS

Further advantageous embodiments of the instant disclosure are disclosed in the following description of the figures and the dependent claims.

FIG. 1a is a perspective view of an embodiment of a printed circuit board arrangement,

FIGS. 1b and 1c is a perspective views of an embodiment of a female terminal,

FIGS. 2a and 2b are perspective views of another embodiment of a female terminal,

FIG. 3a is a perspective view of an embodiment of a printed circuit board arrangement,

FIGS. 3b and 3c are perspective views of another embodiment of a female terminal,

FIG. 4a is a perspective view of an embodiment of a printed circuit board arrangement,

FIG. 4b is a perspective view of another embodiment of a female terminal, and

FIG. 4c is a sectional view of the female terminal according to FIG. 4b.

In the various figures in the drawing, identical parts are always labelled with the same reference signs.

### DETAILED DESCRIPTION

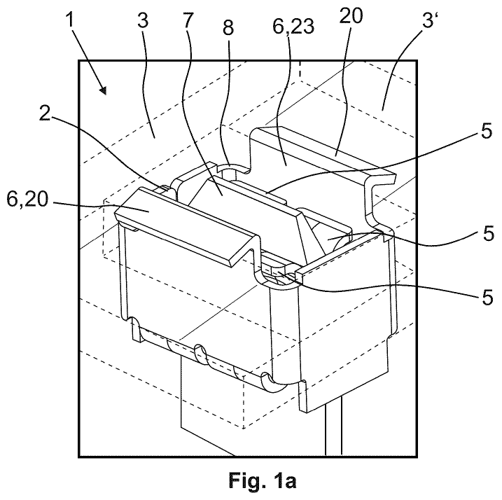

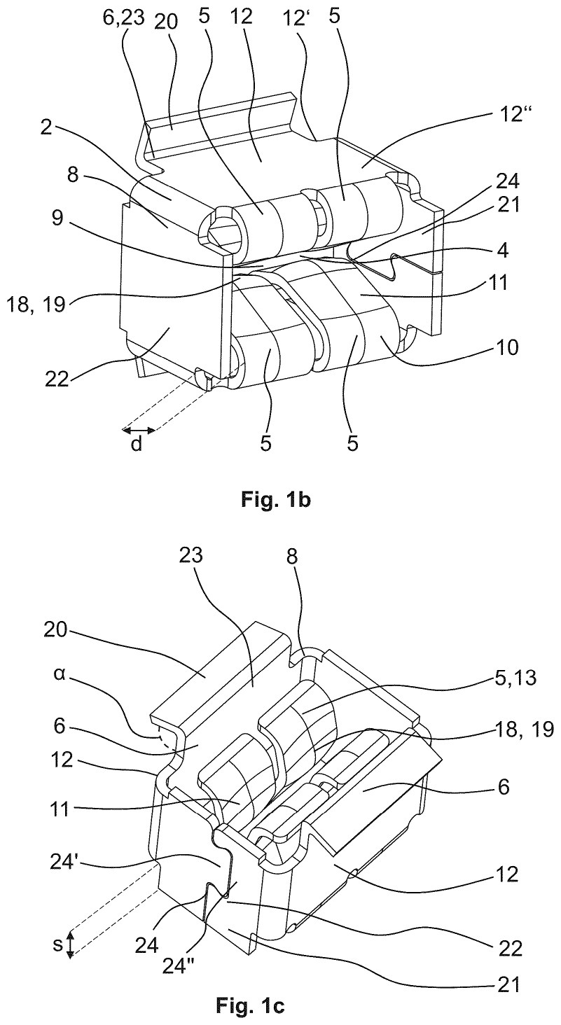

FIG. 1a shows a printed circuit board arrangement 1 according to the an embodiment of the instant disclosure with a female terminal 2 and a printed circuit board 3. In the printed circuit board arrangement 1, the female terminal 2 is partially arranged inside the printed circuit board 3. Furthermore, the female terminal 2 is connected to a conductor track 3′ of the printed circuit board 3.

The female terminal 2 has a plug receptacle 4, at least one first spring tongue 5, here four spring tongues 5 (see FIG. 1b), and at least one positioning arm 6, here two positioning arms 6. FIGS. 1b and 1c show the female terminal 2 according to FIG. 1 alone.

The plug receptacle 4 is configured and designed to receive a plug 7. The four first spring tongues 5 are arranged adjacent to the plug receptacle 4. The four first spring tongues 5 are configured and designed to hold the plug 7 at least partially in the plug receptacle 4. The positioning arms 6 are configured and designed to position the female terminal 2 on the printed circuit board 3.

Furthermore, the female terminal 2 has a surrounding wall 8, wherein the plug receptacle 4 and the first spring tongues 5 partially surrounded by the surrounding wall 8. The surrounding wall 8 encloses an interior space 9. The first spring tongues 5 are partially arranged within the interior space 9 and delimit the plug receptacle 4 in the interior space 9.

Furthermore, the first spring tongues 5 each have a spring root portion 10. The spring root portion 10 protrudes from the interior space 9, as shown in FIG. 1b. In addition, each of the four first spring tongues 5 has a spring portion 11. The surrounding wall 8 extends with a main wall portion 12 beyond the four spring portions 11. The spring portion 11 is arranged within the interior space 9 of the female terminal 2.

As shown in FIG. 1c, each spring portion 11 of the four first spring tongues 5 has an end portion 13. The end portion 13 is orientated towards the surrounding wall 8, namely towards the main wall portion 12. When a plug 7 is inserted into the plug receptacle 4, the spring tongues 5 are deflected. As a result of the deflection, the end portions 13 of the first spring tongues 5 are supported against the surrounding wall 8 in order to increase the contact force.

In each case, two first spring tongues 5 are formed starting from a main wall portion 12. Not only are two first spring tongues 5 formed on the same main wall portion 12, but also a positioning arm 6. As shown in FIG. 1b, a first spring tongue 5 and a positioning arm 6 are each arranged at opposite end portions 12′ and 12″ of the main wall portion 12. Here, the first spring tongues 5 extend from the spring root portion 10 within the interior space 9 towards the positioning arms 6.

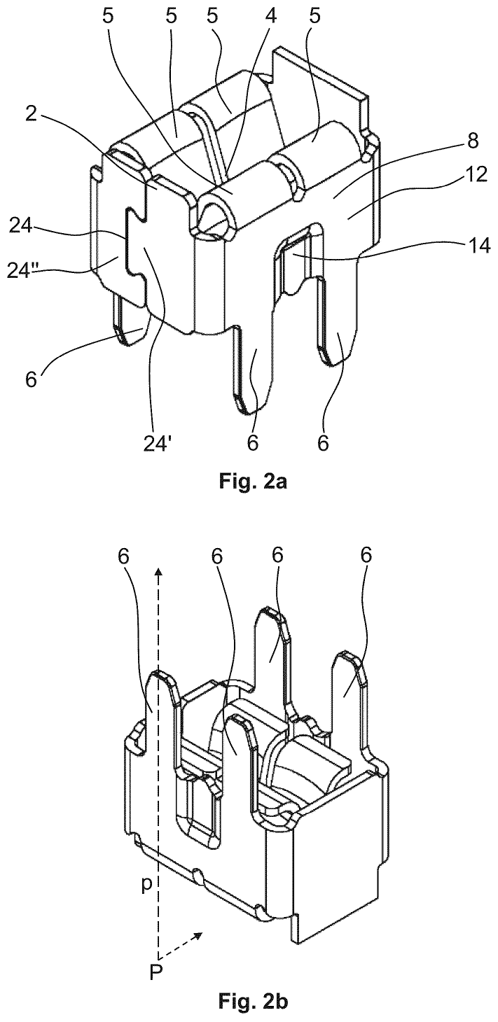

FIGS. 2a and 2b show a further embodiment of the female terminal 2. The female terminal 2 has essentially the same design and the same features as the female terminal 2 as shown in FIGS. 1a, 1b and 1c, so that mainly the differences between the two embodiments are explained in the following.

The female terminal 2 shown in FIGS. 2a and 2b also has first spring tongues 5, here four first spring tongues 5, and positioning arms 6, here four positioning arms 6. In each case, two positioning arms 6 are arranged on a main wall portion 12. An indentation 14 is provided between the two positioning arms 6, which are arranged on the same main wall portion 12.

In the embodiment of FIGS. 2a and 2b, a positioning arm 6 and a spring tongue 5 are each arranged symmetrically about a positioning arm plane P, wherein a positioning arm axis p of the corresponding positioning arm 6 lying in the positioning arm plane P.

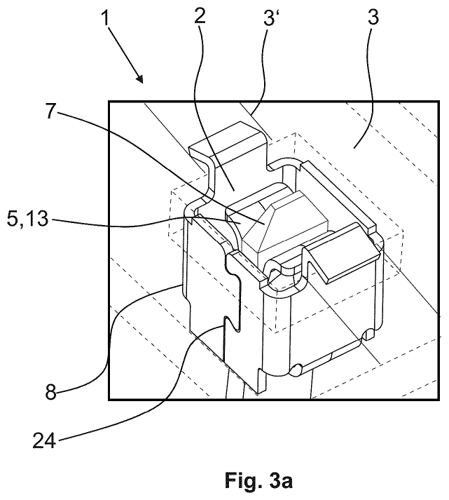

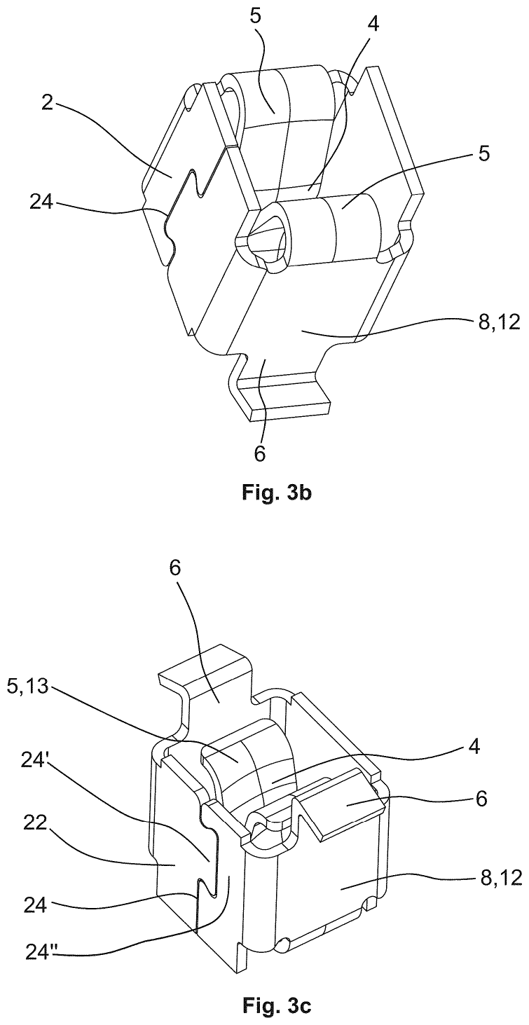

FIG. 3a shows a printed circuit board arrangement 1 in a further embodiment. This printed circuit board arrangement 1 also has a female terminal 2 and a printed circuit board 3. FIG. 3a shows the printed circuit board arrangement 1 with an inserted plug 7. FIGS. 3b and 3c show perspective views of the female terminal 2.

The female terminal 2 according to FIGS. 3a, 3b and 3c has essentially the same design and the same features as the female terminal 2 according to FIGS. 1a, 1b, 1c, 2a and 2b. The printed circuit board arrangement 1 according to FIG. 3a has essentially the same design and the same features as the printed circuit board arrangement 1 according to FIG. 1a. Therefore, mainly the differences to the embodiments of FIGS. 1a to 2b are described in the following.

The female terminal 2 shown in FIGS. 3a, 3b and 3c also has at least one first spring tongue 5, here two spring tongues 5, and at least one positioning arm 6, here two positioning arms 6. In each case, a first spring tongue 5 and a positioning arm 6 are arranged on the same main wall portion 12.

While in the embodiments shown in FIGS. 1a to 2b, the main wall portions 12 are the longest wall portions of the surrounding wall 8, in the embodiment shown in FIGS. 3a to 3c, the two main wall portions 12 are arranged adjacent to a longest wall portion of the surrounding wall 8. The main wall portions 12 thus have a shorter length than a side wall portions 22.

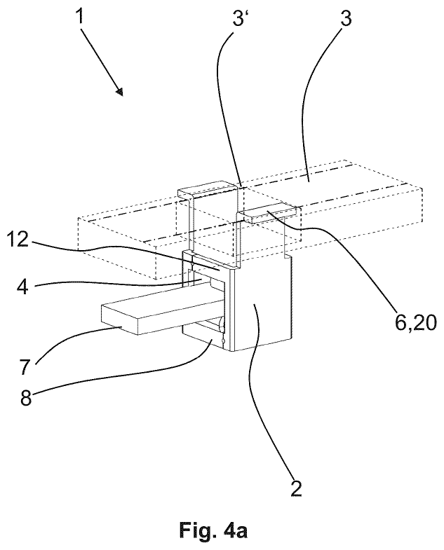

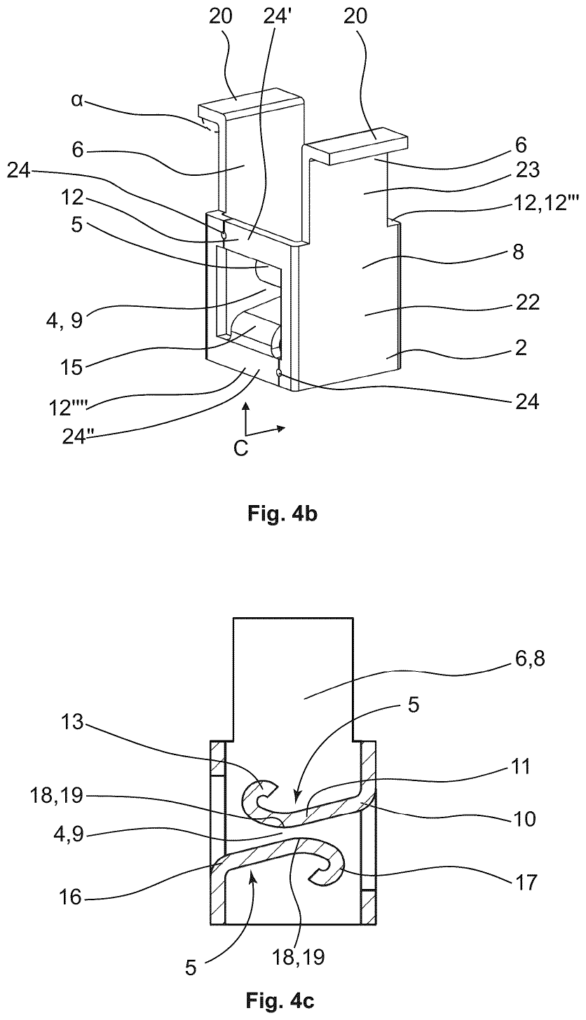

FIG. 4a shows a printed circuit board arrangement 1 in a further embodiment. The printed circuit board arrangement 1 according to FIG. 4a also has a female terminal 2 and a printed circuit board 3. The female terminal 2 is connected to a conductor track 3′ of the printed circuit board 3. The conductor track 3′ is shown with a dotdashed line. FIG. 4a also shows the printed circuit board arrangement 1 with an inserted plug 7. FIG. 4b shows the female terminal 2 of FIG. 4a in a perspective view and FIG. 4c the female terminal 2 in a sectional view in a sectional plane C, wherein the sectional plane C intersects both main wall portions 12 and extends substantially parallel to a side wall portion 22.

The female terminal 2 according to FIGS. 4a, 4b and 4c has essentially the same design and the same features as the female terminals 2 according to FIGS. 1a, 1b, 1c, 2a, 2b, 3a and 3b, so that only the differences between the embodiments are set out in the following. The printed circuit board arrangement 1 according to FIG. 4a has essentially the same design and the same features as the printed circuit board arrangements 1 according to FIGS. 1a and 3a. Therefore, mainly the differences between the embodiments are described in the following.

The female terminal 2, as shown in FIGS. 4a, 4b and 4c, has at least one first spring tongue 5, here exactly one first spring tongue 5, and at least one positioning arm 6, here two positioning arms 6. Furthermore, the female terminal 2 has a second spring tongue 15. The second spring tongue 15 has essentially the same design as the first spring tongue 5.

Both the first spring tongue 5 and the second spring tongue 15 are arranged at least partially adjacent to a plug receptacle 4 and extend at least partially into an interior space 9, which is enclosed by the surrounding wall 8.

As shown in FIGS. 4b and 4c, the first spring tongue 5 and the second spring tongue 15 are arranged completely within the interior space 9. A spring root portion 10 of the first spring tongue 5 and a spring root portion 16 of the second spring tongue 15 are also arranged within the interior space 9. Thus, neither the first spring tongue 5 nor the second spring tongue 15 protrudes from the interior space 9.

FIG. 4c shows that the first spring tongue 5 and the second spring tongue 15 are arranged opposed to each other. The spring root portion 10 of the first spring tongue 5 is arranged opposite an end portion 17 of the second spring tongue 15, and the spring root portion 16 of the first spring tongue 5 is arranged opposite an end portion 13 of the first spring tongue 5. As a result, a plug 7 can be advantageously inserted into the female terminal 2 or the plug receptacle 4 from two insertion directions.

Furthermore, the first spring tongue 5 is formed on a first main wall portion 12″ of the surrounding wall 8 and the second spring tongue 15 is formed on a second main wall portion 12″ of the surrounding wall 8. The first main wall portion 12′″ and the second main wall portion 12″ are opposite each other.

As shown in FIGS. 1b and 1c, the first spring tongues 5 have a spring portion 11. The spring portion 11 has a curved shape. Furthermore, each first spring tongue 5 has a contact point 18, wherein the contact point 18 is configured and designed to coalesce into an electrically conductive connection with a plug. The contact point 18 is formed at a peak 19 of the curvature. Likewise, also the first spring tongue 5 and the second spring tongue 15 according to FIGS. 4a to 4c each have a contact point 18 that is formed at a peak 19 of the curvature of the respective spring tongue 5,15. According to FIG. 4c the contact points 18 of the first spring tongue 5 and the second spring tongue 15 are offset from each other.

The embodiments of FIGS. 1a to 3c show plug receptacles 4 which are orientated in such a way that the plug receptacle 4 extends through the printed circuit board 3 in a state in which the female terminal 2 is attached to a printed circuit board 3, i.e. in a mounted state. The female terminal 2 according to FIGS. 4a, 4b, 4c, on the other hand, has a plug receptacle 4 which is orientated such that, in a mounted state, the plug receptacle 4 extends essentially parallel to the printed circuit board 3, in particular parallel to a surface of the printed circuit board 3. Thus, in the mounted state, a plug 7 inserted into the plug receptacle 4 also extends essentially parallel to the printed circuit board 3, as shown in FIG. 4a, for example.

Furthermore, according to FIGS. 4a to 4c each positioning arm 6 has a positioning arm wing 20. The plug receptacle 4 extends essentially parallel to the positioning arm wing 20.

Each positioning arm 6 extends substantially in an extension of the surrounding wall 8. Furthermore, FIG. 4b shows that the positioning arms 6 each extend substantially along a side wall portion 22 of the surrounding wall 8, thus a width of the positioning arm 6 essentially corresponds to a width of the corresponding side wall portion 22. The positioning arms 6 protrude from the side wall portions 22.

According to the embodiments of FIG. 1a to 3c the positioning arms 6 extend substantially in an extension of the surrounding wall 8. The positioning arms 6 each protrude from a main wall portion 12 of the surrounding wall 8.

The female terminal 2 as shown in FIGS. 1b and 1c has at least one protective protrusion 21, here two protective protrusions 21. Each protective protrusion 21 is arranged on a side wall portion 22. The side wall portion 22 is a portion of the surrounding wall 8 that is different from the main wall portion 12. The side wall portion 22 is arranged adjacent to the main wall portion 12.

According to FIG. 1b, the spring root portion 10 protrudes from the main wall portion 12 by a spring root extension d. The spring root extension d is approximately as large as a protective protrusion extension s (see FIG. 1c). The protective protrusion extension s describes the extent to which the protective protrusion 21 protrudes from the side wall portion 22.

In the embodiment of the female terminal 2 shown in FIGS. 1a to 1c, the positioning arms 6 also have a positioning arm wing 20. Furthermore, the positioning arms 6 have a positioning arm web 23. The positioning arm wing 20 protrudes at an angle α from the positioning arm 6, in particular from the positioning arm web 23. In the embodiment shown in FIGS. 1a to 1c, the angle α is approximately 75°.

The positioning arm wings 20 of the embodiment of the female terminal 2 shown in FIGS. 4a to 4c also protrude at an angle α from the respective positioning arm 6, in particular a positioning arm web 23 of the respective positioning arm 6. According to this embodiment, the angle α is approximately 90°.

In the embodiments according to FIGS. 1a to 3c, the female terminal 2 is formed in one piece from a blank made of sheet metal. In order to produce a surrounding wall 8, the surrounding wall 8 has a joint 24. At the joint 24, two opposing ends 24′ and 24″ of the blank are joined together using a dovetail joint. The joint 24 is arranged on one of the side wall portions 22.

In the embodiment according to FIGS. 4a to 4c, the female terminal 2 is formed in one piece from a blank made of sheet metal. In order to produce a surrounding wall 8, the surrounding wall 8 has two joints 24 in one of the main wall portions 12. The joints 24 feature a welding spot, in particular a laser-welding spot, that connects the opposing ends 24′, 24″ of the blank. The two joints 24 are offset to each other in relation to the second spring tongue 15.

The instant disclosure includes the following non-limiting embodiments:

A female terminal for a printed circuit board, the female terminal comprising: a plug receptacle, a first spring tongue, and a positioning arm, wherein the plug receptacle is configured and designed to at least partially accommodate a plug; wherein the first spring tongue is arranged at least partially adjacent to the plug receptacle; wherein the first spring tongue is configured and designed to hold the plug at least partially in the plug receptacle; wherein the positioning arm is configured and designed to position the female terminal on the printed circuit board; and wherein the plug receptacle and the first spring tongue are at least partially surrounded by a surrounding wall.

The female terminal according to any preceding embodiment, wherein the surrounding wall encloses an interior space, and that the first spring tongue is arranged at least partially within the interior space.

The female terminal according to any preceding embodiment, wherein the first spring tongue has a spring root portion, and that the spring root portion protrudes from the interior space.

The female terminal according to any preceding embodiment, wherein the first spring tongue has a spring portion, and that the surrounding wall extends beyond the spring portion.

The female terminal according to any preceding embodiment, wherein a main wall portion of the surrounding wall extends beyond the spring portion.

The female terminal according to any preceding embodiment, wherein the spring portion is arranged within the interior space.

The female terminal according to any preceding embodiment, wherein the spring portion has an end portion orientated towards the surrounding wall.

The female terminal according to any preceding embodiment, wherein the end portion is at least partially supported on the surrounding wall when a plug is inserted into the plug receptacle.

The female terminal according to any preceding embodiment, wherein the end portion is at least partially supported on the main wall portion of the surrounding wall when a plug is inserted into the plug receptacle.

The female terminal according to any preceding embodiment, wherein the end portion is at least partially supported on the surrounding wall when a plug is inserted into the plug receptacle in order to increase a contact force.

The female terminal according to any preceding embodiment, wherein the first spring tongue extends from a main wall portion of the surrounding wall.

The female terminal according to any preceding embodiment, wherein the first spring tongue and the positioning arm extend from a main wall portion of the surrounding wall.

The female terminal according to any preceding embodiment, wherein the first spring tongue and the positioning arm are arranged at opposite end portions of a main wall portion of the surrounding wall.

The female terminal according to any preceding embodiment, wherein the surrounding wall encloses an interior space; and wherein the first spring tongue extends in the interior space toward the positioning arm.

The female terminal according to any preceding embodiment, further comprising a second spring tongue, wherein the first spring tongue is arranged at least partially opposed to the second spring tongue.

The female terminal according to any preceding embodiment, wherein the first spring tongue and the second spring tongue are formed starting from opposite main wall portions of the surrounding wall.

The female terminal according to any preceding embodiment, wherein the first spring tongue is curved, and in that the first spring tongue has at least one contact point for a plug.

The female terminal according to any preceding embodiment, wherein the plug receptacle is orientated in such a way that, in a mounted state, the plug receptacle extends parallel to the printed circuit board.

The female terminal according to any preceding embodiment, wherein the plug receptacle extends essentially parallel to a positioning arm wing of the positioning arm.

The female terminal according to any preceding embodiment, wherein the positioning arm extends substantially in an extension of the surrounding wall.

The female terminal according to any preceding embodiments, wherein the positioning arm extends substantially in an extension of the surrounding wall.

The female terminal according to any preceding embodiment, wherein the positioning arm extends essentially along a main wall portion of the surrounding wall.

The female terminal according to any preceding embodiment, wherein the positioning arm protrudes from a main wall portion.

The female terminal according to any preceding embodiment, wherein the surrounding wall comprises at least one protective protrusion.

The female terminal according to any preceding embodiment, wherein the protective protrusion is arranged on a side wall portion that is different from a main wall portion.

The female terminal according to any preceding embodiment, wherein the protective protrusion is arranged on a side wall portion adjacent to the main wall portion.

The female terminal according to any preceding embodiment, wherein the first spring tongue has a spring root portion, that the spring root portion protrudes from the interior space, that the spring root portion projects from the main wall portion by a spring root extension (d), and that the spring root extension (d) is approximately as large as a protective protrusion extension(s) by which the protective protrusion projects from the side wall portion.

The female terminal according to any preceding embodiment, wherein the positioning arm has at least one positioning arm web and at least one positioning arm wing, and that the positioning arm wing protrudes at an angle (α) from the positioning arm.

The female terminal according to any preceding embodiment, wherein the angle (α) is between 45° and 135° or that the angle (α) is between 60° and 120° or that the angle (α) is approximately 75° or that the angle (α) is approximately 90°.

The female terminal according to any preceding embodiment, wherein the female terminal is formed in one piece.

The female terminal according to any preceding embodiment, wherein the female terminal is produced in one piece from a blank made of sheet metal by bending.

The female terminal according to any preceding embodiment, wherein the surrounding wall comprises at least one joint.

The female terminal according to any preceding embodiment, wherein two ends of a blank are joined together at the joint by means of at least one of a dovetail joint or a weld.

The female terminal according to any preceding embodiment, wherein the joint is arranged on a side wall portion of the surrounding wall.

A printed circuit board arrangement, comprising at least one printed circuit board, and at least one female terminal according to any preceding embodiment, wherein the female terminal is arranged at least partially within the printed circuit board, wherein the female terminal is electrically conductively connected to at least one conductor track of the printed circuit board.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

What is claimed is:

1. A female terminal for a printed circuit board, the female terminal comprising:
a plug receptacle,
a first spring tongue, and
a positioning arm,
wherein the plug receptacle is configured and designed to at least partially accommodate a plug;
wherein the first spring tongue is arranged at least partially adjacent to the plug receptacle;
wherein the first spring tongue is configured and designed to hold the plug at least partially in the plug receptacle;
wherein the positioning arm is configured and designed to position the female terminal on the printed circuit board; and
wherein the plug receptacle and the first spring tongue are at least partially surrounded by a surrounding wall.

2. The female terminal according to claim 1, wherein the surrounding wall encloses an interior space, and that the first spring tongue is arranged at least partially within the interior space.

3. The female terminal according to claim 2, wherein the first spring tongue has a spring root portion, and that the spring root portion protrudes from the interior space.

4. The female terminal according to claim 2, wherein the first spring tongue has a spring portion, and that the surrounding wall extends beyond the spring portion.

5. The female terminal according to claim 4, wherein a main wall portion of the surrounding wall extends beyond the spring portion.

6. The female terminal according to claim 5, wherein the spring portion is arranged within the interior space.

7. The female terminal according to claim 6, wherein the spring portion has an end portion orientated towards the surrounding wall.

8. The female terminal according to claim 7, wherein the end portion is at least partially supported on the surrounding wall when a plug is inserted into the plug receptacle.

9. The female terminal according to claim 8, wherein the end portion is at least partially supported on the main wall portion of the surrounding wall when a plug is inserted into the plug receptacle.

10. The female terminal according to claim 8, wherein the end portion is at least partially supported on the surrounding wall when a plug is inserted into the plug receptacle in order to increase a contact force.

11. The female terminal according to claim 1, wherein the first spring tongue extends from a main wall portion of the surrounding wall.

12. The female terminal according to claim 1, wherein the first spring tongue and the positioning arm extend from a main wall portion of the surrounding wall.

13. The female terminal according to claim 1, wherein the first spring tongue and the positioning arm are arranged at opposite end portions of a main wall portion of the surrounding wall.

14. The female terminal according to claim 1, wherein the surrounding wall encloses an interior space; and
wherein the first spring tongue extends in the interior space toward the positioning arm.

15. The female terminal according to claim 1, further comprising a second spring tongue, wherein the first spring tongue is arranged at least partially opposed to the second spring tongue.

16. The female terminal according to claim 15, wherein the first spring tongue and the second spring tongue are formed starting from opposite main wall portions of the surrounding wall.

17. The female terminal according to claim 16, wherein the first spring tongue is curved, and in that the first spring tongue has at least one contact point for a plug.

18. The female terminal according to claim 1, wherein the plug receptacle is orientated in such a way that, in a mounted state, the plug receptacle extends parallel to the printed circuit board.

19. The female terminal according to claim 18, wherein the plug receptacle extends essentially parallel to a positioning arm wing of the positioning arm.

20. The female terminal according to claim 19, wherein the positioning arm extends substantially in an extension of the surrounding wall.
